(19) United States
(12) Patent Application Publication
(10) Pub. No.: US 2018/0208740 A1
(43) Pub. Date: Jul. 26, 2018

(54) POLYMERIC MATERIALS

(71) Applicant: Victrex Manufacturing Limited, Lancashire (GB)

(72) Inventors: Alice Matthews, Lancashire (GB); Michael Toft, Lancashire (GB); Dianne Flath, Lancashire (GB); Craig Meakin, Lancashire (GB)

(21) Appl. No.: 15/744,432

(22) PCT Filed: Jul. 22, 2016
(86) PCT No.: PCT/GB2016/052225

§ 371 Date: Jan. 12, 2018

(30) Foreign Application Priority Data
Jul. 24, 2015 (GB) 1513135.2

(51) Int. Cl. C08K 3/22; C08G 65/40; C08K 3/30; C08J 3/20

(52) U.S. Cl. CPC C08K 3/22; C08G 65/4012; C08K 3/30; C08J 2371/10; C08K 2003/3045; C08K 2003/3036; C08K 2003/2241; C08J 3/201

(57) ABSTRACT

A composition comprising titanium dioxide, barium sulphate and/or zinc sulphide and one or more polymeric material selected from: i) a polymeric material (A) having a repeat unit of formula —O-Ph-O-Ph-CO-Ph- I and a repeat unit of formula —O-Ph-Ph-O-Ph-CO-Ph II wherein Ph represents a phenylene moiety; and/or ii) a polymeric material (B) having a repeat unit of formula —X-Ph-(X-Ph-)A-Ph-CO-Ph-III and a repeat unit of formula —X—Y—W-Ph-Z—W wherein Ph represents a phenylene moiety; each X independently represents an oxygen or sulphur atom; n represents an integer of 1 or 2; Y is selected from a phenylene moiety, a -Ph-Ph moiety and a naphthalenyl moiety; W is a carbonyl group, an oxygen or sulphur atom, Z is selected from —X-Ph-SO₂-Ph- —X-Ph-SO₂—Y—SO₂-Ph- and —CO-Ph-.

This invention relates to compositions comprising titanium dioxide, barium sulphate and/or zinc sulphide and one or more polymeric materials, specifically copolymers containing either i) poly-(ether-phenyl-ether-phenyl-carbonyl-phenyl)-(i.e. polyetheretherketone, PEEK) and poly-(ether-phenyl-phenyl-ether-phenyl-carbonyl-phenyl)- (i.e. polyetherdiphenyletherketone, PEDEK), ii) poly-(ether-phenyl-ether-phenyl-ether-phenyl-carbonyl-phenyl)- (i.e. polyetheretheretherketone, PEEEK) and PEDEK or iii) PEEEK and poly-(ether-phenyl-ether-phenyl-ether-phenyl-sulphonyl-phenyl)- (i.e. polyetheretherethersulphone, PEEES).

There is a wide range of thermoplastic polymeric materials available for use in industry, either alone or as part of composite materials. Polyetheretherketone (PEEK) is a high performance, semi-crystalline thermoplastic with excellent mechanical and chemical resistance properties. PEEK is the material of choice for many commercial applications due to its high level of crystallinity and hence outstanding chemical resistance. Whilst PEEK has a suitable glass transition temperature (Tg) of 143° C., its melting temperature (Tm) of 343° C. is much higher than is desirable for processing. Thus for some applications it is beneficial to use materials such as PEEK-PEDEK-copolymers, PEEEK-PEDEK-copolymers and/or PEEEK-PEEES-copolymers which possess relatively low Tm values but exhibit Tg values that are comparable to PEEK.

Furthermore, there is a need in a number of fields (for example in the electronics industry for components for mobile phones, tablets etc.) for thermoplastic polymeric material-based compositions that exhibit as white a colour as possible, i.e. compositions that exhibit a higher lightness, L* (according to the 1976 CIE L* a* b* colour space). Components manufactured from such compositions are useful because they enable ease of colour matching with similarly white-coloured components. It is easier to adjust the colour and/or match (e.g. by addition of colourants) a lighter polymer compared to the light brown/beige colour of virgin PEEK. Furthermore, in general, white polymers and whiter components made therefrom are desirable since whiteness implies higher purity and quality. In addition, it would be beneficial to provide thermoplastic polymeric material-based compositions that also demonstrate improved mechanical properties such as tensile and flexural modulus and flexural strength characteristics. The tensile modulus or Young's modulus measures the force (per unit area) that is needed to stretch (or compress) a material sample. The flexural modulus of a material measures its tendency to bend. The flexural strength of a material is defined as its ability to resist deformation under load. These mechanical attributes are of importance in a wide range of fields.

According to a first aspect of the invention, there is provided a composition comprising one or more of titanium dioxide, barium sulphate and/or zinc sulphide and one or more polymeric material selected from:

i) a polymeric material (A) having a repeat unit of formula

—O-Ph-O-Ph-CO-Ph- I

and a repeat unit of formula

—O-Ph-Ph-O-Ph-CO-Ph II

wherein Ph represents a phenylene moiety; and/or
ii) a polymeric material (B) having a repeat unit of formula

—X-Ph-(X-Ph-)ₙX-Ph-CO-Ph- III

and a repeat unit of formula

—X—Y—W-Ph-Z— IV

wherein Ph represents a phenylene moiety; each X independently represents an oxygen or sulphur atom; n represents an integer of 1 or 2; Y is selected from a phenylene moiety, a -Ph-Ph moiety and a naphthalenyl moiety; W is a carbonyl group, an oxygen or sulphur atom, Z is selected from

### —X-Ph-SO₂-Ph-

—X-Ph-SO₂—Y—SO₂-Ph- and

### —CO-Ph-.

The composition as described herein was found, surprisingly, to exhibit significantly higher L* values, i.e. was found to be significantly lighter than PEEK. Additionally, this composition unexpectedly provides improved tensile and flexural modulus and flexural strength characteristics.

In the following discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

References herein such as “in the range x to y” are meant to include the interpretation “from x to y” and so include the values x and y.

Preferably the composition comprises at least 1 wt % titanium dioxide, barium sulphate and/or zinc sulphide, more preferably at least 5 wt % titanium dioxide, barium sulphate and/or zinc sulphide, even more preferably at least 10 wt % titanium dioxide, barium sulphate and/or zinc sulphide, even more preferably at least 15 wt % titanium dioxide, barium sulphate and/or zinc sulphide, even more preferably at least 20 wt % titanium dioxide, barium sulphate and/or zinc sulphide, most preferably at least 25 wt % titanium dioxide, barium sulphate and/or zinc sulphide. Preferably the composition comprises at most 50 wt % titanium dioxide, barium sulphate and/or zinc sulphide, more preferably at most 40 wt % titanium dioxide, barium sulphate and/or zinc sulphide, even more preferably at most 35 wt % titanium dioxide, barium sulphate and/or zinc sulphide, most preferably at most 30 wt % titanium dioxide, barium sulphate and/or zinc sulphide. These preferred values enable further improvements in the lightness and mechanical properties of the composition.

In some embodiments preferably the composition comprises at least 50 wt % said polymeric material (A) and/or said polymeric material (B), more preferably at least 60 wt %, even more preferably at least 65 wt %, most preferably at least 70 wt %. In some embodiments preferably the composition comprises at most 99 wt % said polymeric material (A) and/or said polymeric material (B), more preferably at most 95 wt %, more preferably at most 85 wt %, even more preferably at most 80 wt %, most preferably at most 75 wt %. These preferred values enable further improvements in the mechanical properties of the composition.

In some embodiments, the sum of the wt % of said polymeric material (A) and/or said polymeric material (B) and titanium dioxide, barium sulphate and/or zinc sulphide preferably represents at least 90 wt %, more preferably at least 95 wt %, especially at least 99 wt % of said composition. Thus, said composition may consist essentially of polymeric material (A) and/or said polymeric material (B) and titanium dioxide, barium sulphate and/or zinc sulphide. In some preferred embodiments said composition may consist of polymeric material (A) and/or said polymeric material (B) and titanium dioxide, barium sulphate and/or zinc sulphide. In some embodiments preferably said composition consists of polymeric material (A) and/or said polymeric material (B) and titanium dioxide.

In some preferred embodiments the one or more polymeric material is polymeric material (A).

### The Following Features are Applicable to Polymeric Material (A):

Preferably, in polymeric material (A), the following relationship applies:

log₁₀(X %)>1.50−0.26 MV;

wherein X % refers to the % crystallinity measured as described in Example 31 of WO2014207458A1 incorporated herein, and MV refers to the melt viscosity measured using capillary rheometry operating at 340° C. at a shear rate of 1000 s⁻¹ using a circular cross-section tungsten carbide die, 0.5 mm (capillary diameter)×3.175 mm (capillary length). The MV measurement is taken 5 minutes after the polymer has fully melted, which is taken to be 5 minutes after the polymer is loaded into the barrel of the rheometer.

The phenylene moieties (Ph) in each repeat unit may independently have 1,4-para linkages to atoms to which they are bonded or 1,3-meta linkages. Where a phenylene moiety includes 1,3-linkages, the moiety will be in the amorphous phase of the polymer. Crystalline phases will include phenylene moieties with 1,4-linkages. In many applications it is preferred for the polymeric material to be highly crystalline and, accordingly, the polymeric material preferably includes high levels of phenylene moieties with 1,4-linkages.

In a preferred embodiment, at least 95%, preferably at least 99%, of the number of phenylene moieties (Ph) in the repeat unit of formula I have 1,4-linkages to moieties to which they are bonded. It is especially preferred that each phenylene moiety in the repeat unit of formula I has 1,4-linkages to moieties to which it is bonded.

In a preferred embodiment, at least 95%, preferably at least 99%, of the number of phenylene moieties (Ph) in the repeat unit of formula II have 1,4-linkages to moieties to which they are bonded. It is especially preferred that each phenylene moiety in the repeat unit of formula II has 1,4-linkages to moieties to which it is bonded.

Preferably, the phenylene moieties in repeat unit of formula I are unsubstituted. Preferably, the phenylene moieties in repeat unit of formula II are unsubstituted.

Said repeat unit of formula I suitably has the structure

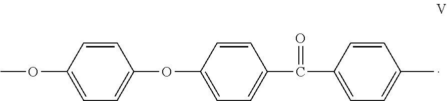

Said repeat unit of formula II suitably has the structure

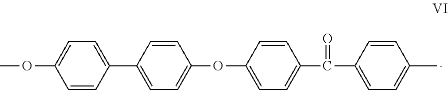

Preferred polymeric materials (A) in accordance with the invention have a crystallinity which is greater than expected from the prior art. Preferably, log₁₀ (X %)>1.50−0.23 MV. More preferably log₁₀ (X %)>1.50−0.28 MV+0.06 MV².

Preferably the repeat units I and II are in the relative molar proportions 1:11 of from 50:50 to 95:5, more preferably of from 60:40 to 95:5, most preferably of from 65:35 to 95:5, e.g. 75:25.

Said polymeric material (A) may include at least 50 mol %, preferably at least 60 mol % of repeat units of formula I. Particular advantageous polymeric materials (A) may include at least 62 mol %, or, especially, at least 64 mol % of repeat units of formula I. Said polymeric material (A) may include less than 90 mol %, suitably 82 mol % or less of repeat units of formula I. Said polymeric material (A) may include 58 to 82 mol %, preferably 60 to 80 mol %, more preferably 62 to 77 mol % of units of formula I.

Said polymeric material (A) may include at least 10 mol %, preferably at least 18 mol %, of repeat units of formula II. Said polymeric material (A) may include less than 42 mol %, preferably less than 39 mol % of repeat units of formula II. Particularly advantageous polymeric materials (A) may include 38 mol % or less; or 36 mol % or less of repeat units of formula II. Said polymeric material (A) may include 18 to 42 mol %, preferably 20 to 40 mol %, more preferably 23 to 38 mol % of units of formula II.

The sum of the mol % of units of formula I and II in said polymeric material (A) is suitably at least 95 mol %, is preferably at least 98 mol %, is more preferably at least 99 mol % and, especially, is about 100 mol %.

The ratio defined as the mol % of units of formula I divided by the mol % of units of formula II may be in the range 1.4 to 5.6, is suitably in the range 1.6 to 4 and is preferably in the range 1.8 to 3.3.

The Tm of said polymeric material (A) (suitably measured as described herein) may be less than 330° C., is suitably less than 320° C., is preferably less than 310° C. In some embodiments, the Tm may be less than 306° C. The Tm may be greater than 280° C., or greater than 290° C., 295° C. or 300° C. The Tm is preferably in the range 300° C. to 310° C.

The Tg of said polymeric material (A) (suitably measured as described herein) may be greater than 130° C., preferably greater than 135° C., more preferably 140° C. or greater. The Tg may be less than 175° C., less than 165° C., less than 160° C. or less than 155° C. The Tg is preferably in the range 145° C. to 155° C.

The difference (Tm-Tg) between the Tm and Tg may be at least 130° C., preferably at least 140° C., more preferably at least 150° C. The difference may be less than 170° C. or less than 165° C. In a preferred embodiment, the difference is in the range 145-165° C.

In a preferred embodiment, said polymeric material (A) has a Tg in the range 145° C.-155° C., a Tm in the range 300° C. to 310° C. and the difference between the Tm and Tg is in the range 145° C. to 165° C.

Said polymeric material (A) may have a crystallinity of at least 25%, measured as described in Example 31 of WO2014207458A1 incorporated herein.

Said polymeric material (A) suitably has a melt viscosity (MV) of at least 0.09 kNsm⁻², preferably has a MV of at least 0.15 kNsm⁻², more preferably at least 0.20 kNsm⁻², especially at least 0.25 kNsm⁻². MV is suitably measured using capillary rheometry operating at 340° C. at a shear rate of 1000 s⁻¹ using a tungsten carbide die, 0.5 mm×3.175 mm. Said polymeric material (A) may have a MV of less than 1.8 kNsm⁻², suitably less than 1.2 kNsm⁻², preferably less than 0.8 kNsm⁻², most preferably less than 0.7 kNsm⁻².

Said polymeric material (A) may have a tensile strength, measured in accordance with ISO527 of at least 40 MPa, preferably at least 60 MPa, more preferably at least 80 MPa. The tensile strength is preferably in the range 80-110 MPa, more preferably in the range 80-100 MPa.

Said polymeric material (A) may have a flexural strength, measured in accordance with ISO178 of at least 130 MPa. The flexural strength is preferably in the range 135-180 MPa, more preferably in the range 140-150 MPa.

Said polymeric material (A) may have a flexural modulus, measured in accordance with ISO178 of at least 2 GPa, preferably at least 3 GPa. The flexural modulus is preferably in the range 3.0-4.5 GPa, more preferably in the range 3.0-4.0 GPa.

### The Following Features are Applicable to Polymeric Material (B):

The phenylene moieties in each repeat unit may independently have 1,4-linkages to atoms to which they are bonded or 1,3-linkages. Where a phenylene moiety includes 1,3-linkages, the moiety will be in amorphous phases of the polymer. Crystalline phases will include phenylene moieties with 1,4-linkages. In many situations it is preferred for the polymeric material to be crystalline and, accordingly, said polymeric material preferably includes phenylene moieties with 1,4-linkages.

In a preferred embodiment, each Ph moiety in the repeat unit of formula III has 1,4-linkages to moieties to which it is bonded.

In a preferred embodiment, each Ph moiety in the repeat unit of formula IV has 1,4-linkages to moieties to which it is bonded.

In repeat unit III, each X preferably represents an oxygen atom.

Preferably, n represents 1.

In repeat unit III, preferably each phenylene moiety has 1,4-linkages to atoms to which it is bonded.

In repeat unit IV, each X preferably represents an oxygen atom.

Preferably, Y is selected from a phenylene moiety and a -Ph-Ph- moiety, wherein each Ph moiety in said -Ph-Ph- includes 1,4-linkages. More preferably, Y is a -Ph-Ph- moiety wherein each phenylene moiety has 1,4-linkages.

Preferably, W represents an oxygen atom.

Preferably, Z is —CO-Ph-, suitably wherein Ph has 1,4-linkages.

In a preferred embodiment, said repeat unit of formula III has the structure:

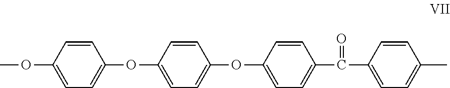

and said repeat unit of formula IV has the structure:

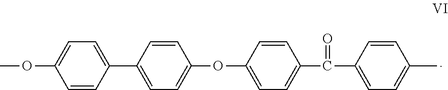

The Tm of said polymeric material (B) may be less than 298° C., alternatively less than 296° C., is suitably less than 293° C., is preferably less than 290° C. In some embodiments, the Tm may be less than 287° C. or less than 285° C. The Tm may be greater than 270° C., or greater than 275° C., 280° C. or 285° C. The Tm is preferably in the range 280° C. to 295° C.

The Tg of said polymeric material (B) may be greater than 120° C., preferably greater than 130° C., more preferably 133° C. or greater. The Tg may be less than 175° C., less than 150° C., less than 140° C. or less than 130° C. The Tg is preferably in the range 130° C. to 140° C.

The difference (Tm-Tg) between the Tm and Tg may be at least 130° C., preferably at least 140° C., more preferably at least 150° C. The difference may be less than 170° C. or less than 161° C. In a preferred embodiment, the difference is in the range 150-160° C.

In a preferred embodiment, said polymeric material (B) has a Tg in the range 130° C.-140° C., a Tm in the range 285° C. to 292° C. and the difference between the Tm and Tg is in the range 150° C. to 161° C.

Said polymeric material (B) may have a crystallinity, measured as described in Example 31 of WO2014207458A1 incorporated herein, of at least 10%, preferably at least 20%, more preferably at least 25%. The crystallinity may be less than 50% or less than 40%.

Said polymeric material (B) suitably has a melt viscosity (MV) of at least 0.06 kNsm⁻², preferably has a MV of at least 0.08 kNsm⁻², more preferably at least 0.085 kNsm⁻², especially at least 0.09 kNsm⁻². MV is suitably measured using capillary rheometry operating at 400° C. at a shear rate of 1000 s⁻¹ using a tungsten carbide die, 0.5×3.175 mm. Said polymeric material (B) may have a MV of less than 1.00 kNsm⁻², suitably less than 0.5 kNsm⁻².

Said polymeric material may (B) have a tensile strength, measured in accordance with ASTM D790 of at least 40 MPa, preferably at least 60 MPa, more preferably at least 80 MPa. The tensile strength is preferably in the range 80-110 MPa, more preferably in the range 80-100 MPa.

Said polymeric material (B) may have a flexural strength, measured in accordance with ASTM D790 of at least 145 MPa. The flexural strength is preferably in the range 145-180 MPa, more preferably in the range 145-165 MPa.

Said polymeric material (B) may have a flexural modulus, measured in accordance with ASTM D790, of at least 2 GPa, preferably at least 3 GPa, more preferably at least 3.5 GPa. The flexural modulus is preferably in the range 3.5-4.5 GPa, more preferably in the range 3.5-4.1 GPa.

Said polymeric material (B) may include at least 50 mol %, preferably at least 60 mol %, more preferably at least 65 mol %, especially at least 70 mol % of repeat units of formula III. Particular advantageous polymeric materials (B) may include at least 72 mol %, or, especially, at least 74 mol % of repeat units of formula III. Said polymeric material (B) may include less than 85 mole %, suitably 80 mol % or less of repeat units of formula III. Said polymeric material (B) may include 68 to 82 mole %, preferably 70 to 80 mol %, more preferably 72 to 77 mol % of units of formula III.

Said polymeric material (B) may include at least 15 mol %, preferably at least 20 mol %, of repeat units of formula IV. Said polymeric material (B) may include less than 50 mol %, preferably less than 40 mol %, more preferably less than 35 mol %, especially less than 30 mol % of repeat units of formula IV. Particularly advantageous polymeric materials (B) may include 28 mol % or less; or 26 mol % or less. Said polymeric material (B) may include 18 to 32 mol %, preferably 20 to 30 mol %, more preferably 23 to 28 mol % of units of formula IV.

The sum of the mole % of units of formula III and IV in said polymeric material is suitably at least 95 mol %, is preferably at least 98 mol %, is more preferably at least 99 mol % and, especially, is about 100 mol %.

The ratio defined as the mole % of units of formula III divided by the mole % of units of formula IV may be in the range 1.8 to 5.6, is suitably in the range 2.3 to 4 and is preferably in the range 2.6 to 3.3.

### The Following Features are Generally Applicable to the Present Invention:

The composition may further comprise a polymeric material (C) which includes a repeat unit of general formula

CR¹R²—CR³R⁴ VIII

wherein R¹ and R² independently represent a hydrogen atom or an optionally-substituted (preferably un-substituted) alkyl group, and R³ and R⁴ independently represent a hydrogen atom or an optionally-substituted alkyl group, an anhydride-containing moiety or an alkyloxycarbonyl-containing moiety.

The presence of polymeric material (C) can improve the impact resistance of the composition, which is important for components such as those used in the field of electronics as they need to endure sometimes extreme handling conditions as phones, tablets etc. are often inadvertently dropped from the hands of users or may fall out of bags or pockets. Said polymeric material (C) also increases the lightness of the composition which is of course advantageous as detailed above.

Said polymeric material (C) is preferably not crystalline. Said polymeric material (C) is preferably amorphous.

Said polymeric material (C) may have a softening point (sometimes equated to a Tm although since the material (C) is preferably not crystalline there is preferably no sharp Tm) of at least 100° C., preferably at least 120° C. The softening point may be less than 200° C. Said polymeric material (C) is preferably a fluid (i.e. it flows) at a temperature of 200° C., for example at 170° C.

Said polymeric material (C) may have a decomposition temperature measured by thermogravimetric analysis (TGA) in accordance with ISO11358 or as described in ‘Thermal analysis of polymers—fundamentals & applications. Editors Joseph D Menczel and R Bruce Prime, Wiley-Blackwell, 1^{st} Edition 2009. of less than 400° C. for example less than 390° C. Said polymeric material (C) may have a decomposition temperature of less than 350° C. or even less than 330° C., The onset of decomposition may be less than 380° C. Said polymeric material (C) may show onset of decomposition at a temperature of less than 320° C. or even less than 300° C.

Said polymeric material (A) and said polymeric material (C) are preferably substantially immiscible. Said polymeric material (B) and said polymeric material (C) are preferably substantially immiscible. Said polymeric material (A) and said polymeric material (C) suitably exhibit different Tgs. Said polymeric material (B) and said polymeric material (C) suitably exhibit different Tgs.

Said polymeric material (C) preferably does not include any chlorine atoms. Said polymeric material (C) preferably does not include any fluorine atoms. Said polymeric material (C) preferably does not include any halogen atoms.

Said polymeric material (C) preferably does not include any nitrogen atoms. It preferably does not include any sulphur atoms. It preferably does not include any silicon atoms.

Preferably, said polymeric material (C) includes carbon, hydrogen and oxygen atoms. Preferably, the only atoms included in said polymeric material (C) are carbon, hydrogen and oxygen atoms.

Said polymeric material (C) may have a Tg of less than 0° C., preferably less than minus 20° C. for example less than minus 40° C.

Said polymeric material (C) may have a softening point of greater than 100° C. The softening point may be less than 160° C.

Said polymeric material (C) may have an elongation at break of greater than 450%.

Said polymeric material (C) may have a tensile strength of greater than 9000 KPa.

In said repeat unit of general formula VIII of said polymeric material (C), R¹ and R² may be independently selected from a hydrogen atom and a C₁₋₄, preferably a C₁₋₂, non-substituted alkyl moiety. Preferably, R¹ and R² both represent a hydrogen atom.

Suitably, R³ and R⁴ independently represent a hydrogen atom, a non-substituted C₁₋₁₀ alkyl group, an alkyloxycarbonyl-containing moiety (e.g. a C₁₋₄ alkyloxycarbonyl-containing moiety) and an anhydride-containing moiety (e.g. a cyclic anhydride containing moiety).

Suitably, R³ represents a hydrogen atom or a C₁₋₄ alkyl group which is preferably non-substituted.

Suitably, R⁴ represents a C₁₋₁₀ alkyl group or an alkyloxycarbonyl-containing moiety. When it is an alkyloxycarbonyl-containing moiety, said carbonyl moiety is preferably directly covalently bonded to the carbon atom in moiety —CR³R⁴— in formula VIII. When it is an alkyloxycarbonyl-containing moiety, said moiety may be of formula

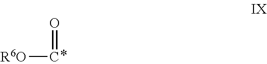

where the starred carbon atom represents the atom covalently bonded to the carbon atom in moiety —CR³R⁴—.

R⁶ may represent a C₁₋₁₀ alkyl moiety (especially a non-substituted moiety), preferably a C₁₋₆ alkyl moiety (especially a non-substituted moiety), more preferably a C₁₋₄ alkyl moiety (especially a non-substituted moiety).

In one embodiment, R⁶ may represent a butyl group; in another, it may represent a methyl group.

When R⁴ is an alkyloxycarbonyl-containing moiety, for example of formula IX as described, said polymeric material (C) may be an acrylate core-shell type polymer. It may include a core which comprises a polyalkylacrylate. Suitably, the alkyl moiety in said polyalkylacrylate is a C₁₋₆, for example a C₂₋₅, especially a C₃₋₄ non-substituted alkyl moiety. The core may comprise a polybutylacrylate. The core may include a repeat unit of the following formula (before any cross-linking of the repeat unit)

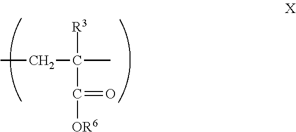

suitably wherein R⁶ is as described, but is preferably a non-substituted butyl group, and R³ may be as described but is preferably a hydrogen atom.

When said polymeric material (C) is a core-shell type polymer, the core may be as described and the shell may be of formula X wherein, preferably, R⁶ represents a C₁₋₄, more preferably, a C₁₋₂ non-substituted alkyl moiety and R³ represents a hydrogen atom or a C₁₋₂, especially a methyl, group.

Said polymeric material (C) may include 70 to 90 wt % (preferably 76 to 84 wt %) of said core and 10 to 30 wt % (preferably 16 to 24 wt %) of said shell.

In an embodiment (I), polymeric material (C) may comprise a core-shell polymer wherein the core comprises an alkyl acrylate (especially butyl acrylate) and the shell comprises an alkylacrylate (especially polymethylmethacrylate).

In an embodiment (II), R⁴ may represent an anhydride-containing moiety. The anhydride-containing moiety may be a cyclic anhydride, for example a part of a 5- or 6-membered ring. It preferably comprises a maleic anhydride moiety.

In an embodiment (III), said polymeric material (C) may comprise a copolymer which may include a first repeat unit of general formula VIII and a second repeat unit of general formula VIII.

Said first repeat unit of general formula VIII may include a group R⁴ which represents an anhydride-containing moiety. The anhydride-containing moiety may be a cyclic anhydride, for example part of a 5- or 6-membered ring. R⁴ preferably comprises a maleic anhydride moiety. The anhydride moiety may be directly covalently bonded to the carbon atom which is starred in the following moiety —C*R³R⁴—.

In said first repeat unit, R¹, R² and R³ may be as described herein. Preferably, they are independently selected from a hydrogen atom and a C₁₋₄, especially a C₁₋₂ non-substituted alkyl group. Preferably, in said first repeat unit R¹, R² and R³ represent hydrogen atoms.

In said second repeat unit, of general formula VIII of said embodiment (III), R⁴ may comprise an optionally-substituted, preferably unsubstituted, C₂₋₁₄ (e.g. C₂₋₈) alkyl, alkenyl or alkylyl group. Preferably, R⁴ represents a non-substituted C₂₋₁₂ (e.g. C₂₋₈) alkyl group. More preferably, R⁴ represents a non-substituted C₃₋₁₂ (e.g. C₄₋₈) alkyl group. Preferred alkyl groups are linear. In an especially preferred embodiment, R⁴ represents a C₅₋₇, especially a C₆ alkyl group.

In said second repeat unit, R¹, R² and R³ may be as described herein. Preferably, they are independently selected from a hydrogen atom and a C₁₋₄, especially a C₁₋₂ non-substituted alkyl group. Preferably, in said first repeat unit, R¹, R² and R³ represent hydrogen atoms.

In said embodiment (III), said first repeat unit may comprise:

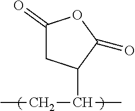

In said embodiment (III), aid second repeat unit may comprise:

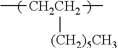

In said composition, the ratio of the wt % of said polymeric material (A) and/or said polymeric material (B) divided by the wt % of all polymeric materials in said composition is preferably at least 0.75, preferably at least 0.82, more preferably at least 0.87. Said ratio may be less than 0.98 or less than 0.94.

In said composition, the ratio of the wt % of said polymeric material (A) and/or said polymeric material (B) divided by the sum of the wt % of said polymeric material (A) and/or said polymeric material (B) and said polymeric material (C) is preferably at least 0.75, preferably at least 0.82, more preferably at least 0.87. Said ratio may be less than 0.98 or less than 0.94.

The composition may comprise at least 0.5 wt % of polymeric material (C), more preferably at least 1 wt % of polymeric material (C), even more preferably at least 5 wt % of polymeric material (C), even more preferably at least 8 wt % of polymeric material (C), most preferably at least 10 wt % of polymeric material (C). Preferably the composition comprises at most 30 wt % of polymeric material (C), more preferably at most 20 wt % of polymeric material (C), even more preferably at most 10 wt % of polymeric material (C). These preferred values enable further improvements in the lightness and mechanical properties of the composition.

In a more preferred embodiment the composition may comprise at least 0.25 wt %, preferably at least 0.5 wt % of polymeric material (C), but preferably at most 5 wt %, more preferably at most 4 wt %, even more preferably at most 3 wt %, even more preferably at most 2 wt % of polymeric material (C).

Said composition preferably includes only two thermoplastic materials—said polymeric material (A) or said polymeric material (B), and said polymeric material (C). For the avoidance of doubt, said polymeric material (C) may be a core-shell polymer as described.

In some embodiments said composition preferably includes said polymeric material (C). An especially preferred polymeric material (C) is said polymeric material (C) of said embodiment (III).

Said composition may consist essentially of polymeric material (A) and/or said polymeric material (B), and titanium dioxide, barium sulphate and/or zinc sulphide, and polymeric material (C). In some preferred embodiments said composition may consist of polymeric material (A) and/or said polymeric material (B), and titanium dioxide, barium sulphate and/or zinc sulphide, and polymeric material (C). In some embodiments preferably said composition consists of polymeric material (A) and/or said polymeric material (B), and titanium dioxide, and polymeric material (C).

Said composition may have a crystallinity measured as described in Example 31 of WO2014207458A1 incorporated herein of at least 20%, preferably at least 22%, more preferably at least 24%. The crystallinity may be less than 30%.

Said composition may have a tensile strength, measured in accordance with ISO527 (specimen type 1 b) tested at 23° C. at a rate of 50 mm/minute of at least 30 MPa, of at least 50 MPa, preferably at least 70 MPa. The tensile strength is preferably in the range 70-90 MPa.

Said composition may have a tensile modulus, measured in accordance with ISO527 (ISO527-1a test bar, tested in uniaxial tension at 23° C. at a rate of 1 mm/minute), of at least 2 GPa, preferably at least 2.5 GPa. The tensile modulus is preferably in the range 2.5-4.1 GPa.

Said composition may have a flexural strength, measured in accordance with ISO178 (80 mm×10 mm×4 mm specimen, tested in three-point-bend at 23° C. at a rate of 2 mm/minute), of at least 105 MPa. The flexural strength is preferably in the range 110-170 MPa, more preferably in the range 115-160 MPa.

Said composition may have a flexural modulus, measured in accordance with ISO178 (80 mm×10 mm×4 mm specimen, tested in three-point-bend at 23° C. at a rate of 2 mm/minute), of at least 2 GPa, preferably at least 2.5 GPa. The flexural modulus is preferably in the range 2.5-4 GPa.

The composition may have a Notched Izod Impact Strength (specimen 80 mm×10 mm×4 mm with a cut 0.25 mm notch (Type A), tested at 23° C., in accordance with ISO180) of at least 4 KJm⁻², preferably at least 5 KJm⁻², more preferably at least 10 KJm⁻², even more preferably at least 12 KJm⁻². The Notched Izod Impact Strength may be less than 50 KJm⁻², suitably less than 30 KJm⁻², more preferably less than 20 KJm⁻², most preferably less than 18 KJm⁻².

Said composition suitably has a melt viscosity of less than 320 Pa·s, preferably less than 300 Pa·s, more preferably less than 290 Pa·s. MV is suitably measured using capillary rheometry operating at 340° C. at a shear rate of 1000 s-1 using a tungsten carbide die, 0.5 mm×3.175 mm.

The difference between the MV of said composition and said polymeric material (A) or said polymeric material (B) is preferably at least 30 Pa·s.

The crystallinity of said composition minus the crystallinity of said polymeric material (A) or said polymeric material (B) is suitably greater than minus 3, preferably greater than minus 2.

Advantageously, said composition is found to be lighter (i.e. has a higher L*, measured as described herein in Example 9). Thus, said composition may have an L* when measured in accordance with Example 9 of at least 70, preferably at least 80, more preferably at least 85, most preferably at least 90. The ratio of the L* of said composition divided by the L* of said polymeric material (A) or said polymeric material (B) is preferably at least 1.10, more preferably at least 1.15, especially at least 1.20.

Said composition preferably comprises an intimate blend of said polymeric material (A) and/or said polymeric material (B) and titanium dioxide. Such a blend may be prepared by melt-processing, for example by extrusion.

Said composition may include a polymeric material (D) having one or more repeat unit of formula

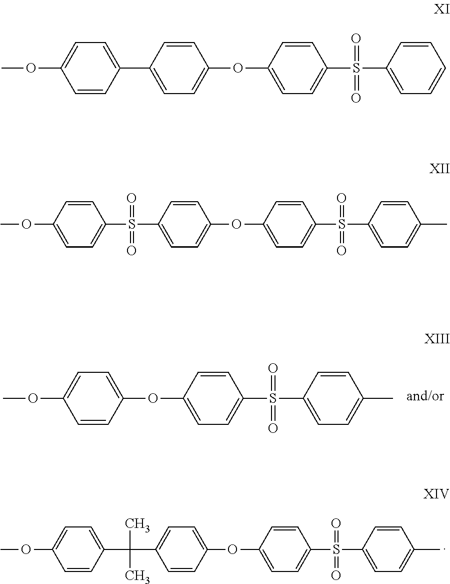

Said polymeric material (D) may include at least 75 mol %, preferably at least 90 mol %, more preferably at least 99 mol %, especially at least 100 mol % of repeat units of formula XI, XII, XIII and/or XIV.

Said polymeric material (D) may be a homopolymer or a copolymer, for example a random or block copolymer. When polymeric material (D) is a copolymer, it may include more than one repeat unit selected from formula XI, XII, XIII and/or XIV.

In a preferred embodiment, polymeric material (D) includes said repeat unit of formula XI.

Said polymeric material (D) may have a melt flow rate (MFR) equal to or higher than 5 g/10 min at 365° C. and under a load of 5.0 kg, preferably equal to or higher than 10 g/10 min at 365° C. and under a load of 5.0 kg, more preferably equal to or higher than 14 g/10 min at 365° C. and under a load of 5.0 kg, as measured in accordance with ASTM method D1238; to measure said melt flow rate, a Tinius Olsen Extrusion Plastometer melt flow test apparatus can be used.

Said composition may include 0 to 40 wt % of said polymeric material (D).

Said composition may be provided in the form of pellets or granules. Said pellets or granules suitably comprise at least 90 wt %, preferably at least 95 wt %, especially at least 99 wt % of said composition. Pellets or granules may have a maximum dimension of less than 10 mm, preferably less than 7.5 mm, more preferably less than 5.0 mm.

In one embodiment, said composition may be part of a composite material which may include said composition and a filler. Said filler may include a fibrous filler or a non-fibrous filler. Said filler may include both a fibrous filler and a non-fibrous filler. A said fibrous filler may be continuous or discontinuous.

A said fibrous filler may be selected from inorganic fibrous materials, non-melting and high-melting organic fibrous materials, such as aramid fibres, and carbon fibre.

A said fibrous filler may be selected from glass fibre, carbon fibre, asbestos fibre, silica fibre, alumina fibre, zirconia fibre, boron nitride fibre, silicon nitride fibre, boron fibre, fluorocarbon resin fibre and potassium titanate fibre. Preferred fibrous fillers are glass fibre and carbon fibre. A fibrous filler may comprise nanofibers.

When the filler comprises glass fibre it is preferred that the composition comprises barium sulphate and/or zinc sulphide. When the filler comprises glass fibre it is preferred that the composition does not comprise titanium dioxide.

A said non-fibrous filler may be selected from mica, silica, talc, alumina, kaolin, calcium sulfate, calcium carbonate, titanium oxide, ferrite, clay, glass powder, zinc oxide, nickel carbonate, iron oxide, quartz powder, magnesium carbonate, fluorocarbon resin, graphite, carbon powder, nanotubes and barium sulfate. The non-fibrous fillers may be introduced in the form of powder or flaky particles.

Preferably, said filler comprises one or more fillers selected from glass fibre, carbon fibre, aramid fibres, carbon black and a fluorocarbon resin. More preferably, said filler comprises glass fibre or carbon fibre. Such filler preferably comprises glass fibre.

A composite material as described may include at least 40 wt %, or at least 50 wt % of filler. Said composite material may include 70 wt % or less or 60 wt % or less of filler.

In some embodiments said composition may preferably further comprise one or more antioxidants, such as a phenolic antioxidant (e.g. Octadecyl-3-(3,5-di-tert.butyl-4-hydroxyphenyl)-propionate), an organic phosphite antioxidant (e.g. tris(2,4-di-tert-butylphenyl)phosphite) and/or a secondary aromatic amine antioxidant. In some preferred embodiments said composition may comprise polymeric material (A) and/or polymeric material (B), one or more of titanium dioxide, barium sulphate and/or zinc sulphide, and one or more antioxidant. Said composition may additionally comprise polymeric material (C). In some preferred embodiments said composition may consist of polymeric material (A) and/or polymeric material (B), one or more of titanium dioxide, barium sulphate and/or zinc sulphide, and one or more antioxidant. In other preferred embodiments said composition may consist of polymeric material (A) and/or polymeric material (B), one or more of titanium dioxide, barium sulphate and/or zinc sulphide, polymeric material (C), and one or more antioxidant.

In some embodiments, said composition may be part of a composite material which may include said composition and one or more of stabilizers such as light stabilizers and heat stabilizers, processing aids, pigments, UV absorbers, lubricants, plasticizers, flow modifiers, flame retardants, dyes, colourants, anti-static agents, extenders, metal deactivators, conductivity additives such as carbon black and carbon nanofibrils.

Said composition may define a composite material which could be prepared as described in Impregnation Techniques for Thermoplastic Matrix Composites. A Miller and A G Gibson, Polymer & Polymer Composites 4(7), 459-481 (1996), EP102158 and EP102159, the contents of which are incorporated herein by reference. Preferably, in the method, said composition and said filler means are mixed at an elevated temperature, suitably at a temperature at or above the melting temperature of said polymeric material (A) and/or polymeric material (B). Thus, suitably, said composition and filler means are mixed whilst the polymeric material (A) and/or polymeric material (B) is molten. Said elevated temperature is suitably below the decomposition temperature of the polymeric material (A) and/or polymeric material (B). Said elevated temperature is preferably at or above the main peak of the melting endotherm (Tm) for said polymeric material (A) and/or polymeric material (B). Said elevated temperature is preferably at least 300° C. Advantageously, the molten polymeric material (A) and/or polymeric material (B) can readily wet the filler and/or penetrate consolidated fillers, such as fibrous mats or woven fabrics, so the composite material prepared comprises the composition and filler means which is substantially uniformly dispersed throughout the composition.

The composite material may be prepared in a substantially continuous process. In this case the composition and filler means may be constantly fed to a location wherein they are mixed and heated. An example of such a continuous process is extrusion. Another example (which may be particularly relevant wherein the filler means comprises a fibrous filler) involves causing a continuous filamentous mass to move through a melt or aqueous dispersion comprising said composition. The continuous filamentous mass may comprise a continuous length of fibrous filler or, more preferably, a plurality of continuous filaments which have been consolidated at least to some extent. The continuous fibrous mass may comprise a tow, roving, braid, woven fabric or unwoven fabric. The filaments which make up the fibrous mass may be arranged substantially uniformly or randomly within the mass. A composite material could be prepared as described in PCT/GB2003/001872, U.S. Pat. No. 6,372,294 or EP1215022.

Alternatively, the composite material may be prepared in a discontinuous process. In this case, a predetermined amount of said composition and a predetermined amount of said filler means may be selected and contacted and a composite material prepared by causing the polymeric material to melt and causing the polymeric material and filler means to mix to form a substantially uniform composite material.

In the context of the present invention, the Glass Transition Temperature (Tg), the Cold Crystallisation Temperature (Tn), the Melting Temperature (Tm) and Heat of Fusions of Nucleation (ΔHn) and Melting (ΔHm) are determined using the following DSC method:

A dried sample of a polymer is compression moulded into an amorphous film, by heating 7 g of polymer in a mould at 400° C. under a pressure of 50 bar for 2 minutes, then quenching in cold water producing a film of dimensions 120×120 mm, with a thickness in the region of 0.20 mm. A 8 mg plus or minus 3 mg sample of each film is scanned by DSC as follows:
Step 1 Perform and record a preliminary thermal cycle by heating the sample from 30° C. to 400° C. at 20° C./min.
Step 2 Hold for 5 minutes.
Step 3 Cool at 20° C./min to 30° C. and hold for 5 mins.
Step 4 Re-heat from 30° C. to 400° C. at 20° C./min, recording the Tg, Tn, Tm, ΔHn and ΔHm.

From the DSC trace resulting from the scan in step 4, the onset of the Tg is obtained as the intersection of the lines drawn along the pre-transition baseline and a line drawn along the greatest slope obtained during the transition. The Tn is the temperature at which the main peak of the cold crystallisation exotherm reaches a maximum. The Tm is the temperature at which the main peak of the melting endotherm reaches a maximum.

The Heats of Fusion for Nucleation (ΔHn) and Melting (ΔHm) are obtained by connecting the two points at which the cold crystallisation and melting endotherm(s) deviate from the relatively straight baseline. The integrated areas under the endotherms as a function of time yield the enthalpy (mJ) of the particular transition, the mass normalised Heats of Fusion are calculated by dividing the enthalpy by the mass of the specimen (J/g).

According to a second aspect of the invention, there is provided a method of making a composition according to the first aspect, the method comprising:

(a) selecting a polymeric material (A) and/or a polymeric material (B) according to the first aspect;
(b) melt-processing the polymeric material (A) and/or a polymeric material (B) and one or more of titanium dioxide, barium sulphate and/or zinc sulphide in a melt-processing apparatus, thereby to produce said composition wherein, suitably, said polymeric material (A) and/or a polymeric material (B) and one or more of titanium dioxide, barium sulphate and/or zinc sulphide are intimately mixed.

The invention of the second aspect extends to a method of making a composition as described which has an increased L* (when measured in accordance with Example 9 and with reference to the 1976 CIE L* a* b* colour space) compared to the L* of said polymeric material (A) and/or said polymeric material (B), suitably when L* is assessed as described hereinafter. The invention suitably comprises steps (a) and (b) as described. The L* may be increased by at least 10 or at least 15 units. The method may comprise making a composition as described which has an L* of at least 85, preferably at least 90.

In the method of the second aspect, pellets or granules as described in the first aspect may be prepared.

The invention extends, in a third aspect, to a pack comprising a composition, preferably in the form of powder, pellets and/or granules, as described in the first aspect or made in the method of the second aspect.

Said pack may include at least 1 kg, suitably at least 5 kg, preferably at least 10 kg, more preferably at least 14 kg of material of said composition. Said pack may include 1000 kg or less, preferably 500 kg or less of said composition. Preferred packs include 10 to 500 kg of said composition.

Said pack may comprise packaging material (which is intended to be discarded or re-used) and a desired material (which suitably comprises said composition). Said packaging material preferably substantially fully encloses said desired material. Said packaging material may comprise a first receptacle, for example a flexible receptacle such as a plastics bag in which said desired material is arranged. The first receptacle may be contained within a second receptacle for example in a box such as a cardboard box.

The invention extends, in a fourth aspect, to a component which comprises, preferably consists essentially of, a composition according to the first aspect or made in a method described. Said component may be an injection moulded component or an extruded component. Said component preferably includes at least 10 g (e.g. at least 100 g or at least 1 kg) of said polymeric material (A). Said component preferably includes at least 10 g (e.g. at least 100 g or at least 1 kg) of said composition of said first aspect.

The invention extends, in a fifth aspect, to a method of making a component as described which comprises selecting a composition according to the first aspect and melt-processing, for example by injection moulding or extrusion, said composition to define the component. The component may be as described in the fourth aspect.

According to a sixth aspect of the present invention there is provided the use of titanium dioxide, barium sulphate and/or zinc sulphide to increase the lightness (L*) (when measured in accordance with Example 9 and with reference to the 1976 CIE L* a* b* colour space) of a composition comprising a polymeric material (A) and/or a polymeric material (B) according to the first aspect. Preferably said use is of titanium dioxide to increase the lightness (L*) (when measured in accordance with Example 9 and with reference to the 1976 CIE L* a* b* colour space) of a composition comprising a polymeric material (A) and/or a polymeric material (B) according to the first aspect.

According to a seventh aspect of the present invention there is provided the use of a polymeric material (C) according to the first aspect to increase the lightness (L*) (when measured in accordance with Example 9 and with reference to the 1976 CIE L* a* b* colour space) of a composition comprising a polymeric material (A) and/or a polymeric material (B) according to the first aspect and one or more of titanium dioxide, barium sulphate and/or zinc sulphide. Preferably said composition comprises a polymeric material (A) and/or a polymeric material (B) according to the first aspect and titanium dioxide.

According to an eighth aspect of the present invention there is provided the use of titanium dioxide, barium sulphate and/or zinc sulphide to increase one or more of the tensile modulus (measured in accordance with ISO527 (ISO527-1a test bar, tested in uniaxial tension at 23° C. at a rate of 1 mm/minute)), flexural modulus (measured in accordance with ISO178 (80 mm×10 mm×4 mm specimen, tested in three-point-bend at 23° C. at a rate of 2 mm/minute)) and/or flexural strength (measured in accordance with ISO178 (80 mm×10 mm×4 mm specimen, tested in three-point-bend at 23° C. at a rate of 2 mm/minute)) of a composition comprising a polymeric material (A) and/or a polymeric material (B) according to the first aspect. Preferably said use is of titanium dioxide to increase one or more of the tensile modulus (measured in accordance with ISO527 (ISO527-1a test bar, tested in uniaxial tension at 23° C. at a rate of 1 mm/minute)), flexural modulus (measured in accordance with ISO178 (80 mm×10 mm×4 mm specimen, tested in three-point-bend at 23° C. at a rate of 2 mm/minute)) and/or flexural strength (measured in accordance with ISO178 (80 mm×10 mm×4 mm specimen, tested in three-point-bend at 23° C. at a rate of 2 mm/minute)) of a composition comprising a polymeric material (A) and/or a polymeric material (B) according to the first aspect.

According to an ninth aspect of the present invention there is provided the use of titanium dioxide, barium sulphate and/or zinc sulphide and a polymeric material (C) according to the first aspect to increase the Notched Izod Impact Strength (specimen 80 mm×10 mm×4 mm with a cut 0.25 mm notch (Type A), tested at 23° C., in accordance with ISO180) of a composition comprising a polymeric material (A) and/or a polymeric material (B) according to the first aspect. Preferably said use is of titanium dioxide and a polymeric material (C) according to the first aspect to increase the Notched Izod Impact Strength (specimen 80 mm×10 mm×4 mm with a cut 0.25 mm notch (Type A), tested at 23° C., in accordance with ISO180) of a composition comprising a polymeric material (A) and/or a polymeric material (B) according to the first aspect.

According to an tenth aspect of the present invention there is provided the use of the composition according to the first aspect, the pack according to the third aspect, or the component according to the fourth aspect in automotive, aerospace, medical, electronic, oil and/or gas applications.

According to an eleventh aspect of the present invention there is provided the use of a polymeric material (C) according to the first aspect to decrease the delta E (when measured in accordance with Example 9 and with reference to the 1976 CIE L* a* b* colour space) exhibited by a composition upon exposure to UV radiation (e.g. when tested in accordance with the SAE J2527 protocol), wherein said composition comprises a polymeric material (A) and/or a polymeric material (B) according to the first aspect and one or more of titanium dioxide, barium sulphate and/or zinc sulphide.

It will be appreciated that optional features applicable to one aspect of the invention can be used in any combination, and in any number. Moreover, they can also be used with any of the other aspects of the invention in any combination and in any number. This includes, but is not limited to, the dependent claims from any claim being used as dependent claims for any other claim in the claims of this application.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

Specific embodiments of the invention will now be described, by way of example: The following materials are referred to hereinafter:

Compound B—refers to Paraloid EXL3361 (Trade Mark) methyl methacrylate-butadiene-styrene (MBS) core-shell copolymer obtained from Dow Chemicals.
Compound C—refers to Paraloid EXL3808 (Trade Mark) maleic anhydride functionalised ethylene octane copolymer obtained from Dow Chemicals.
Additive A=Process and thermal stabiliser, Irgafos 168 (Trade Mark) (obtained from BASF).
Additive B=Process and thermal stabiliser, Irganox 1076 (Trade Mark) (obtained from BASF).
Additive C=Titanium dioxide, Tioxide TR28 (Trade Mark) (obtained from Huntsman).

In the following description, Example 1 describes preparation of a copolymer. Examples 2 to 6 describe the preparation of compositions for testing optionally including the copolymer and Example 7 describes the injection moulding of such compositions. Examples 8 to 11 describe assessments undertaken on the compositions and/or parts made therefrom.

### EXAMPLE 1—PREPARATION OF POLYETHERETHERKETONE (PEEK)—POLYETHERDIPHENYLETHERKETONE (PEDEK) COPOLYMER

A 300 litre vessel fitted with a lid, stirrer/stirrer guide, nitrogen inlet and outlet was charged with diphenylsulphone (125.52 kg) and heated to 150° C. Once fully melted 4,4′-diflurobenzophenone (44.82 kg, 205.4 mol), 1,4-dihydroxybenzene (16.518 kg, 150 mol) and 4,4′-dihydroxydiphenyl (9.311 kg, 50 mol) were charged to the vessel. The contents were then heated to 160° C. While maintaining a nitrogen blanket, dried sodium carbonate (21.368 kg, 201.6 mol) and potassium carbonate (1.106 kg, 8 mol), both sieved through a screen with a mesh of 500 micrometres, were added. The D50 of the sodium carbonate was 98.7 μm. The temperature was raised to 180° C. at 1° C./min and held for 100 minutes. The temperature was raised to 200° C. at 1° C./min and held for 20 minutes. The temperature was raised to 305° C. at 1° C./min and held until desired melt viscosity was reached, as determined by the torque rise of the stirrer. The required torque rise was determined from a calibration graph of torque rise versus MV. The reaction mixture was poured via a band caster into a water bath, allowed to cool, milled and washed with acetone and water. The resulting polymer powder was dried in a tumble dryer until the contents temperature measured 112° C. The MV of the resulting polymer was 225 Pa·s measured according to Example 8 at 340° C. and the crystallinity was 24% measured according to as described herein.

### EXAMPLES 2 TO 6—PREPARATION OF COMPOSITIONS

The raw materials referred to in Table 1 were tumble blended using a ZSK twin-screw extruder operating with a barrel temperature of 315° C., die temperature of 320° C. and screw speed of 300 rpm. The throughput in each case was 13-14 kg/hour.

TABLE 1

| | Examples No. | | | | |
|---|---|---|---|---|---|
| | 2 | 3 | 4 | 5 | 6 |
| PEEK-PEDEK | 100 wt % | 90 wt % | 79 wt % | 79 wt % | 80 wt % |
| copolymer | | | | | |
| of Example 1 | | | | | |
| Compound B | — | — | — | 10 wt % | — |
| Compound C | — | 10 wt % | 10 wt % | — | — |
| Additive A | — | — | 0.5 wt % | 0.5 wt % | — |
| Additive B | — | — | 0.5 wt % | 0.5 wt % | — |
| Additive C | — | — | 10 wt % | 10 wt % | 20 wt % |

### EXAMPLE 7—PREPARATION OF TEST BARS

Standard type 1A ISO test bars (ISO 3167) were injection moulded using each of the compositions of Examples 2 to 6 on a Haitian injection moulding machine with a barrel temperature of 320° C.-335° C., nozzle temperature of 335° C. and a tool temperature of 160° C. Amorphous test bars of the compositions of Examples 2 to 6 were also moulded using the same procedure except that the tool temperature was less than 140° C.

The compositions and/or test bars were assessed as described in Examples 8 to 11.

### EXAMPLE 8—DETERMINATION OF MELT VISCOSITY (MV) OF POLYMERS

Unless otherwise stated herein, this was measured using a Bohlin Instruments RH2000 capillary rheometer according to ISO 11443 operating at 340° C. and a shear rate of 1000 s⁻¹ using a 0.5 mm (capillary diameter)×8.0 mm (capillary length) die with entry angle 180° C. Granules are loaded into the barrel and left to pre-heat for 10 minutes. The viscosity is measured once steady state conditions are reached and maintained, nominally 5 minutes after the start of the test.

### EXAMPLE 9—COLOUR MEASUREMENTS

Unless otherwise stated herein, colour measurements were carried out on injection moulded ISO test bars made as described in Example 7. The measurements were made using a Konica Minolta Chromameter with a DP400 data processor operating over a spectral range of 360 nm to 750 nm. A white plate calibration was carried out with a D65 (natural daylight) light source. Colour measurements are expressed at L*, a* and b* coordinates as defined by the CIE 1976 (Nassau, K. Kirk-Othmer Encyclopaedia of Chemical Technology, chapter 7, page 303-341, 2004). Values were determined from a single point on the ISO test bar.

### EXAMPLE 10—MECHANICAL PROPERTIES

The mechanical properties of the compositions of Examples 2 to 6 were tested according to ISO standards using the type 1A (ISO 3167) test bars at 23° C., except for the Notched Izod Impact Strength testing of the test bars moulded at a tool temperature of less than 140° C. which was carried out in accordance with ASTM D256.

The compositions of Examples 2 to 6 and/or test bars made therefrom were assessed in the tests of Examples 8 to 10. In addition, the time for the test bar to solidify so that it could be injected from the injection moulding machine was assessed and is referred to as the “cooling time” in seconds. Results are provided in Table 2.

TABLE 2

| | Example assessed | | | | |
|---|---|---|---|---|---|
| Assessment | 2 | 3 | 4 | 5 | 6 |
| Processing temp (° C.) | 340 | 335 | 335 | 335 | 335 |
| Cooling time, moulding (s) | 120 | 35 | 35 | 35 | 120 |
| Colour (L*) | 72.6 | 86.4 | 92.1 | 91.8 | 91.2 |
| Melt Viscosity (Pa.s) | 225 | 170 | 165 | 125 | 285 |
| Tensile Modulus (GPa) | 3.5 | 2.8 | 2.6 | 2.9 | 4.0 |
| Tensile Strength at yield (MPa) | 92 | 71 | 67 | 66 | 82 |
| Tensile Strength at break (MPa) | 64 | 52 | 54 | 56 | 60 |
| Flexural Modulus (GPa) | 3.4 | 2.7 | 2.4 | 2.9 | 3.9 |
| Flexural Strength (MPa) | 150 | 121 | 113 | 121 | 151 |
| Notched Izod Impact | 4.2 | 6.5 | 13.0 | 16 | 5.9 |
| Strength (KJm⁻²) | | | | | |
| (Test Bar Moulded At | | | | | |
| Tool Temperature of 160° C.) | | | | | |
| Notched Izod Impact | 1550 | — | 1033 | 322 | 390 |
| Strength (J/m) | | | | | |
| (Test Bar Moulded At Tool | | | | | |
| Temperature of less than | | | | | |
| 140° C.) | | | | | |

The following should be noted from the results in Table 2:

Examples 2 and 3 are comparative examples since the compositions of those examples do not contain titanium dioxide.

Example 6 (20 wt % Additive C (titanium dioxide)) exhibits superior tensile modulus and flexural modulus values in comparison with all of the other examples. Additionally, the flexural strength of Example 6 is vastly superior to that of all of the other examples except for that of Example 2 (PEEK-PEDEK copolymer) which is at the same level.

Example 6, along with Examples 4 (10 wt % titanium dioxide, 10 wt % compound C) and 5 (10 wt % titanium dioxide, 10 wt % compound B), all exhibit very high lightness in comparison with the PEEK-PEDEK copolymer of Example 2 and that of PEEK polymer (L* of 68-70 for Victrex (Trade Mark) PEEK 150G).

The crystalline test bars moulded at a tool temperature of 160° C. of Examples 4 and 5 both display far greater Notched Izod Impact Strength than those of the other examples.

The amorphous test bars moulded at a tool temperature of less than 140° C. of Examples 4 to 6 exhibited acceptable Notched Izod Impact Strength, with Example 4 displaying a particularly high value.

### EXAMPLE 11—FURTHER COLOUR MEASUREMENTS

A further PEEK-PEDEK copolymer (Copolymer (i)) was prepared in accordance with Example 1, but this time the MV of the resulting copolymer was 260 Pa·s measured according to Example 8 at 340° C. The raw materials referred to for each sample in Table 3 were tumble blended using a ZSK twin-screw extruder operating with a barrel temperature of 315° C., die temperature of 320° C. and screw speed of 300 rpm. The throughput in each case was 13-14 kg/hour. Colour measurements in accordance with Example 9 were carried out on injection moulded ISO test bars made as described in Example 7 using the compositions set out for each of the samples in Table 3. The results are shown in Table 3.

TABLE 3

| Sample | L* value | a* value | b* value |
|---|---|---|---|
| 100 wt % Copolymer (i) | 70.262 | 4.04 | 5.16 |
| 97 wt % Copolymer (i) + 3 wt % | 82.55 | 1.78 | 7.14 |
| Compound C | | | |
| 73 wt % Copolymer (i) + 27 wt % | 90.55 | 0.48 | 3.66 |
| Additive C | | | |
| 72 wt % Copolymer (i) + 1 wt % | 92.666 | 0.23 | 3.21 |
| Compound C + 27 wt % Additive C | | | |
| 70 wt % Copolymer (i) + 3 wt % | 92.544 | 0.24 | 2.81 |
| Compound C + 27 wt % Additive C | | | |
| 68 wt % Copolymer (i) + 5 wt % | 92.57 | 0.13 | 2.23 |
| Compound C + 27 wt % Additive C | | | |

The following should be noted from the results in Table 3:

The addition of 27 wt % Additive C (titanium dioxide) to Copolymer (i) results in a sample with a greatly increased lightness value and a more neutral hue (reduced a* and b* values) than Copolymer (i). Furthermore, the lightness can be raised by another 2 points by introducing small amounts of Compound C. The incorporation of Compound C also results in the colour of the samples moving further towards a neutral hue.

### EXAMPLE 12—FURTHER TESTING OF MECHANICAL PROPERTIES

The samples prepared in Example 11 were tested for their mechanical properties. Test bars of each of these samples were prepared and tested according to ISO 180/A using a Ceast 9050 pendulum impact tester to determine the average Notched Izod Impact Strength (the energy absorbed in breaking a bar) of each sample. The test bars were moulded as set out in the method of example 7 but at a tool temperature of 180° C. The test bars had the dimensions 80 mm×10 mm×4 mm with a cut 0.25 mm notch (Type A). All bars were initially tested using a hammer energy of 1 J and, if a bar failed to break, a corresponding additional bar was prepared and tested according to ISO 180/A using a hammer energy of 5.5 J. The types of breaks observed were either complete breaks (i.e. the bar separates into two or more pieces) or hinge breaks (i.e. the break is incomplete such that two parts of the bar are only held together by a thin peripheral layer in the form of a hinge). The results are shown in Table 4.

TABLE 4

| | Hammer | | Average Notched Izod |
|---|---|---|---|
| Sample | Energy (J) | Type of Break | Impact Strength (kJm⁻²) |
| 100 wt % Copolymer (i) | 1 | 5 samples tested - all | 6.0 |
| | | complete breaks | |
| 97 wt % Copolymer (i) + | 1 | 5 samples tested - all | 9.0 |
| 3 wt % Compound C | | complete breaks | |
| 73 wt % Copolymer (i) + | 1 | 5 samples tested - all | 5.9 |
| 27 wt % Additive C | | complete breaks | |
| 72 wt % Copolymer (i) + | 5.5 | 4 samples tested - all | 45.9 |
| 1 wt % Compound C + | | hinge breaks | |
| 27 wt % Additive C | | | |
| 70 wt % Copolymer (i) + | 5.5 | 3 samples tested - 1 x | 35.4 |
| 3 wt % Compound C + | | hinge break & 2 x | |
| 27 wt % Additive C | | complete breaks | |
| 68 wt % Copolymer (i) + | 1 | 3 samples tested - all | 18.6 |
| 5 wt % Compound C + | | hinge breaks | |
| 27 wt % Additive C | | | |
| 68 wt % Copolymer (i) + | 5.5 | 3 samples tested - 2 x | 18.5 |
| 5 wt % Compound C + | | hinge breaks & 1 x | |
| 27 wt % Additive C | | complete break | |

The following should be noted from the results in Table 4:

The combination of both Additive C (titanium dioxide) and Compound C with Copolymer (i) results in samples that exhibit increased impact strength in impact tests according to ISO 180/A. Additive C (titanium dioxide) and Compound C surprisingly have a synergistic effect on the impact strength of the samples. Furthermore, the impact strength is greatest at a low level (1 wt %) of Compound C and decreases sharply as the amount of Compound C is increased.

Tensile and flexural properties of the samples prepared in Example 11 were tested. The properties were determined in the same manner as the correspondingly-named properties tested in Example 10 above. The results are shown in table 5.

TABLE 5

| | Tensile | Tensile | Tensile | Flexural | Flexural |
|---|---|---|---|---|---|
| | Strength at | Strength at | Modulus | Strength | Modulus |
| Sample | yield (MPa) | break (MPa) | (GPa) | (MPa) | (GPa) |
| 100 wt % Copolymer (i) | 92 | 64 | 3.5 | 150 | 3.4 |
| 97 wt % Copolymer (i) + | 82 | 62 | 3.4 | 136 | 3.0 |
| 3 wt % Compound C | | | | | |
| 73 wt % Copolymer (i) + | 79 | 61 | 4.4 | 145 | 4.1 |
| 27 wt % Additive C | | | | | |
| 72 wt % Copolymer (i) + | 72 | 60 | 4.1 | 134 | 3.8 |
| 1 wt % Compound C + | | | | | |
| 27 wt % Additive C | | | | | |
| 70 wt % Copolymer (i) + | 70 | 58 | 3.2 | 123 | 3.0 |
| 3 wt % Compound C + | | | | | |
| 27 wt % Additive C | | | | | |
| 68 wt % Copolymer (i) + | 69 | 53 | 2.9 | 115 | 2.6 |
| 5 wt % Compound C + | | | | | |
| 27 wt % Additive C | | | | | |

The following should be noted from the results in Table 5:

The addition of Additive C to the Copolymer (i) improves both the tensile and flexural modulus of the sample in comparison with the pure Copolymer (i). Further addition of 1 wt % of Compound C decreases both the tensile and flexural modulus of the sample but the values are still higher than those of the pure Copolymer (i). While the addition of Additive C and Compound C, either alone or in combination, to the Copolymer (i) results in a reduction in both tensile and flexural strength, the values are acceptable. For the combination of Copolymer (i), 27 wt % Additive C and Compound C the highest values for tensile and flexural strength were achieved when using 1 wt % Compound C.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

1. A composition comprising titanium dioxide, barium sulphate and/or zinc sulphide and one or more polymeric material selected from:
i) a polymeric material (A) having a repeat unit of formula
—O-Ph-O-Ph-CO-Ph- I
and a repeat unit of formula
—O-Ph-Ph-O-Ph-CO-Ph II
wherein Ph represents a phenylene moiety; and/or
ii) a polymeric material (B) having a repeat unit of formula
—X-Ph-(X-Ph-V-Ph-CO-Ph- III
and a repeat unit of formula
—X—Y—W-Ph-Z— IV
wherein Ph represents a phenylene moiety; each X independently represents an oxygen or sulphur atom; n represents an integer of 1 or 2; Y is selected from a phenylene moiety, a -Ph-Ph moiety and a naphthalenyl moiety; W is a carbonyl group, an oxygen or sulphur atom, Z is
selected from
X-Ph-SO₂-Ph-
X-Ph-SO₂—Y—SO₂-Ph- and
CO-Ph-.

2. The composition according to claim 1, wherein the composition comprises at least 5 wt % titanium dioxide, barium sulphate and/or zinc sulphide, and/or wherein the composition comprises at most 40 wt % titanium dioxide.

3. (canceled)

4. The composition according to claim 1, wherein said composition consists of polymeric material (A) and/or said polymeric material (B) and titanium dioxide, barium sulphate and/or zinc sulphide.

5. The composition according to claim 1, wherein the one or more polymeric material is polymeric material (A), said repeat unit of formula I has the structure 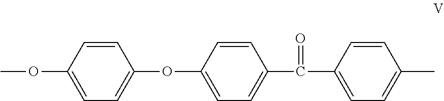
and said repeat unit of formula II has the structure

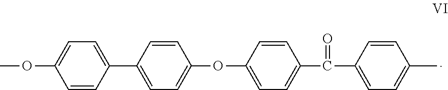

6. The composition according to claim 1, wherein the repeat units I and II are in the relative molar proportions 1:11 of from 60:40 to 95:5.

7. The composition according to claim 1, wherein said polymeric material (A) includes at least 60 mol % of repeat units of formula I, and wherein said polymeric material (A) includes less than 90 mol % of repeat units of formula I.

8. The composition according to claim 1, wherein said polymeric material (A) has a melt viscosity (MV) of at least 0.15 kNsm⁻², and less than 0.8 kNsm⁻², wherein MV is measured using capillary rheometry operating at 340° C. at a shear rate of 1000 s⁻¹ using a tungsten carbide die, 0.5 mm×3.175 mm.

9. The composition according to claim 1, wherein the composition further comprises a polymeric material (C) which includes a repeat unit of general formula
CR¹R²—CR³R⁴ VIII
wherein R¹ and R² independently represent a hydrogen atom or an optionally-substituted alkyl group, and R³ and R⁴ independently represent a hydrogen atom or an optionally-substituted alkyl group, an anhydride-containing moiety or an alkyloxycarbonyl-containing moiety.

10. The composition according to claim 9, wherein:
in said repeat unit of general formula VIII of said polymeric material (C), R¹ and R² may be independently selected from a hydrogen atom and a C₁₋₄ non-substituted alkyl moiety, and R³ and R⁴ independently represent a hydrogen atom, a non-substituted C₁₋₁₀ alkyl group, an alkyloxycarbonyl-containing moiety and an anhydride-containing moiety (e.g. a cyclic anhydride containing moiety); and/or
R⁴ represents a C₁₋₁₀ alkyl group or an alkyloxycarbonyl-containing moiety, and wherein the alkyloxycarbonyl-containing moiety is of formula 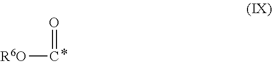
where the starred carbon atom represents the atom covalently bonded to the carbon atom in moiety —CR³R⁴— and R⁶ represents a C₁₋₁₀ alkyl moiety; and/or
the composition comprises at least 0.5 wt % of polymeric material (C); and/or
the composition comprises at least 0.25 wt % of polymeric material (C), but at most 5 wt % of polymeric material (C).

11.-13. (canceled)

14. The composition according to claim 1, wherein:
said composition has a tensile modulus, measured in accordance with ISO527 (ISO527-1a test bar, tested in uniaxial tension at 23° C. at a rate of 1 mm/minute), of at least 2 GPa; and/or
said composition has a flexural strength, measured in accordance with ISO178 (80 mm×10 mm×4 mm specimen, tested in three-point-bend at 23° C. at a rate of 2 mm/minute), in the range 110-170 MPa; and/or
said composition has a flexural modulus, measured in accordance with ISO178 (80 mm×10 mm×4 mm specimen, tested in three-point-bend at 23° C. at a rate of 2 mm/minute), of at least 2 GPa; and/or
said composition has a Notched Izod Impact Strength (specimen 80 mm×10 mm×4 mm with a cut 0.25 mm notch (Type A), tested at 23° C., in accordance with ISO180) of at least 4 KJm⁻²; and/or
said composition has an L* when measured in accordance with Example 9 (with reference to the 1976 CIE L* a* b* colour space) of at least 80.

15-18. (canceled)

19. The composition according to claim 1, wherein said composition is part of a composite material which includes said composition and a filler.

20. A method of making a composition according claim 1, the method comprising:
(a) selecting the polymeric material (A) and/or the polymeric material (B);
(b) melt-processing the polymeric material (A) and/or the polymeric material (B) and one or more of titanium dioxide, barium sulphate and/or zinc sulphide in a melt-processing apparatus, thereby to produce said composition.

21. A pack comprising a composition as described in claim 1.

22. A component comprising a composition according to claim 1, wherein said component is an injection moulded component or an extruded component.

23. A method of increasing the lightness (L*) (when measured in accordance with Example 9 and with reference to the 1976 CIE L* a* b* colour space) of a composition comprising according to claim 1, the method comprising adding titanium dioxide, barium sulphate and/or zinc sulphide to the composition.

24. A method of increasing the lightness (L*) (when measured in accordance with Example 9 and with reference to the 1976 CIE L* a* b* colour space) of a composition according to claim 1, wherein the composition further comprises one or more of titanium dioxide, barium sulphate and/or zinc sulphide, the method comprising adding a polymeric material (C) to the composition, wherein the polymeric material (C) includes a repeat unit of general formula
CR¹R²—CR³R⁴ VIII
wherein R¹ and R² independently represent a hydrogen atom or an optionally-substituted alkyl group, and R³ and R⁴ independently represent a hydrogen atom or an optionally-substituted alkyl group, an anhydride-containing moiety or an alkyloxycarbonyl-containing moiety.

25. A method of increasing one or more of the tensile modulus (measured in accordance with ISO527 (ISO527-1a test bar, tested in uniaxial tension at 23° C. at a rate of 1 mm/minute)), flexural modulus (measured in accordance with ISO178 (80 mm×10 mm×4 mm specimen, tested in three-point-bend at 23° C. at a rate of 2 mm/minute)) and/or flexural strength (measured in accordance with ISO178 (80 mm×10 mm×4 mm specimen, tested in three-point-bend at 23° C. at a rate of 2 mm/minute)) of a composition according to claim 1, the method comprising adding titanium dioxide, barium sulphate and/or zinc sulphide to the composition.

26. A method of increasing the Notched Izod Impact Strength (specimen 80 mm×10 mm×4 mm with a cut 0.25 mm notch (Type A), tested at 23° C., in accordance with ISO180) of a composition according to claim 1, the method comprising adding titanium dioxide, barium sulphate and/or zinc sulphide to the composition, and further comprising adding a polymeric material (C) to the composition, wherein the polymeric material (C) includes a repeat unit of general formula
CR¹R²—CR³R⁴ VIII
wherein R¹ and R² independently represent a hydrogen atom or an optionally-substituted alkyl group, and R³ and R⁴ independently represent a hydrogen atom or an optionally-substituted alkyl group, an anhydride-containing moiety or an alkyloxycarbonyl-containing moiety.

27. A method of using the composition of claim 1, the method comprising incorporating the composition in to a component for automotive, aerospace, medical, electronic, oil and/or gas applications.

28. A method of increasing the delta E (when measured in accordance with Example 9 and with reference to the 1976 CIE L* a* b* colour space) exhibited by a composition upon exposure to UV radiation (e.g. when tested in accordance with the SAE J2527 protocol), wherein said composition is a composition according to claim 1, and wherein the composition further comprises one or more of titanium dioxide, barium sulphate and/or zinc sulphide, the method comprising adding a polymeric material (C) to the composition, wherein the polymeric material (C) includes a repeat unit of general formula
CR¹R²—CR³R⁴ VIII
wherein R¹ and R² independently represent a hydrogen atom or an optionally-substituted alkyl group, and R³ and R⁴ independently represent a hydrogen atom or an optionally-substituted alkyl group, an anhydride-containing moiety or an alkyloxycarbonyl-containing moiety.
